(19) United States
(12) Patent Application Publication
(10) Pub. No.: US 2025/0369997 A1
(43) Pub. Date: Dec. 4, 2025

(54) AIR DATA PROBE INSPECTION TOOL

(71) Applicant: Rosemount Aerospace Inc., Burnsville, MN (US)

(72) Inventor: Matthew Anderson, Lakeville, MN (US)

(21) Appl. No.: 18/675,895

(22) Filed: May 28, 2024

(51) Int. Cl. G01P 5/165

(52) U.S. Cl. CPC G01P 5/165

(57) ABSTRACT

An air data probe inspection tool includes a non-metallic sleeve designed to match the contour of a machined probe head of the air data probe. This sleeve fits onto the probe head and aligns with at least one opening of the probe. The air data probe inspection tool further includes a rigid flag coupled to the non-metallic sleeve, aligning with a probe strut leading edge and a top surface of a baseplate. Together, the sleeve and flag facilitate visual inspection for detecting misalignment or bending of the air data probe during installation or maintenance procedures.

### TECHNICAL FIELD

The present disclosure relates generally to aircraft maintenance tools and, more particularly, to an on-wing inspection tool for assessing the alignment of air data probes installed on aircraft.

### BACKGROUND

Air data probes play a critical role in aircraft operation, providing essential data for flight control systems, navigation, and performance monitoring. These probes, typically installed on the exterior of the aircraft, measure parameters such as airspeed, altitude, and angle of attack. In the manufacturing and maintenance of aircraft, ensuring the proper alignment and straightness of air data probes is crucial to sustain accurate and reliable performance. However, the process of installing and inspecting these probes presents significant challenges to Aircraft Original Equipment Manufacturers (OEMs) and operators alike.

Traditionally, air data probes are installed during the final assembly line of the aircraft. During installation, misalignment, or perceived misalignment of the probe head to the probe strut can occur, leading to air data performance issues during test flights. These issues could then lead to a need for probe replacement and repeat test flights, resulting in increased maintenance costs, downtime, and delays in aircraft delivery. Currently, methods for assessing probe alignment and straightness often rely on manual inspection techniques, which can be time consuming, labor-intensive, and prone to human error. Furthermore, the complexity of aircraft structures and the limited accessibility of air data probe locations intensify the challenges associated with probe inspection and maintenance.

Therefore, there exists a need for a system and method which cure one or more of the shortcomings identified above.

### SUMMARY

An air data probe inspection tool is disclosed, in accordance with one or more embodiments of the present disclosure. In some embodiments, the air data probe inspection tool includes a non-metallic sleeve configured to match the contour of a machined probe head of an air data probe, where the non-metallic sleeve is configured to fit onto the machined probe head and align with at least one opening of the air data probe. In some embodiments, the air data probe inspection tool includes a rigid flag coupled to the non-metallic sleeve, the rigid flag being configured to align with a probe strut leading edge and a top surface of a baseplate. In some embodiments, the non-metallic sleeve and the rigid flag are configured to facilitate visual inspection for at least a misalignment or bending of the air data probe during installation or maintenance procedures.

A method is disclosed, in accordance with one or more embodiments of the present disclosure. In some embodiments, the method may include, but is not limited to, providing an air data inspection tool. In embodiments, the air data inspection tool includes a non-metallic sleeve configured to match the contour of a machined probe head of an air data probe, where the non-metallic sleeve is configured to fit onto the machined probe head and align with at least one opening of the air data probe. In embodiments, the air data inspection tool includes a rigid flag coupled to the non-metallic sleeve, the rigid flag being configured to align with a probe strut leading edge and a top surface of a baseplate of the air data probe. In some embodiments, the method may include, but is not limited to, installing the inspection tool onto the air data probe. In some embodiments, the method may include, but is not limited to, visually inspecting one or more alignment features of the air data probe inspection tool.

It is to be understood that both the foregoing general description and the following detailed description are exemplary and explanatory only and are not necessarily restrictive of the invention as claimed. The accompanying drawings, which are incorporated in and constitute a part of the specification, illustrative embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures in which:

FIGS. 1A-1B illustrate perspective views of the air data probe inspection tool employed on an aircraft wing, in accordance with one or more embodiments of the present disclosure.

FIG. 2A illustrates a front view of the air data probe inspection tool, in accordance with one or more embodiments of the present disclosure.

FIG. 2B illustrates a perspective view of the air data probe inspection tool, in accordance with one or more embodiments of the present disclosure.

FIG. 3A illustrates a perspective view of the air data probe inspection tool employed in a pitot-static system, in accordance with one or more embodiments of the present disclosure.

FIG. 3B illustrates a perspective view of the air data probe inspection tool employed in a pitot-static system, in accordance with one or more embodiments of the present disclosure.

FIG. 4A illustrates a front view of the air data probe inspection tool employed in a pitot-static system, in accordance with one or more embodiments of the present disclosure.

FIG. 4B illustrates a perspective view of the air data probe inspection tool employed in a pitot-static system, in accordance with one or more embodiments of the present disclosure.

FIG. 5 is a flow diagram depicting a method for assessing alignment of an air data probe installed on an aircraft, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

Embodiments of the inventive concepts disclosed herein are directed to an air data probe inspection tool. Air data probe head exteriors are meticulously crafted machined surfaces, and precise alignment during installation is crucial to ensure optimal performance. However, achieving and maintaining this alignment presents significant challenges, particularly given the complex geometry of aircraft structures and the limited accessibility of probe locations. In response to these challenges, the air data probe inspection tool leverages several key features and design principles. First, the inspection tool is engineered to reference off the precisely controlled machined surfaces of the air data probe head, ensuring maximum alignment check repeatability. By avoiding the inlet area and utilizing drain holes and static ports as secondary references for tool installation depth and rotation, the tool enhances accuracy and reliability during the inspection process.

In embodiments, the inspection tool may utilize a non-metallic sleeve, constructed from an engineered thermoplastic material (e.g., Delrin), which resembles the contoured shape of the probe head. For example, the sleeve may serve multiple functions including, but not limited to, the detection of a bent probe head. Further, the inspection tool may incorporate a thin rigid flag attached to the sleeve, which is precisely referenced to the drain holes. The thin rigid flag may provide operators with straightforward visual checks without the need for complex measurements. By way of another example, the flag may be designed to align with both the probe strut leading edge and the top surface of the baseplate, ensuring comprehensive assessment of alignment and straightness. Moreover, the properly angled end of the flag may match the strut rake angle, further enhancing the suitability of the tool for diverse aircraft configurations.

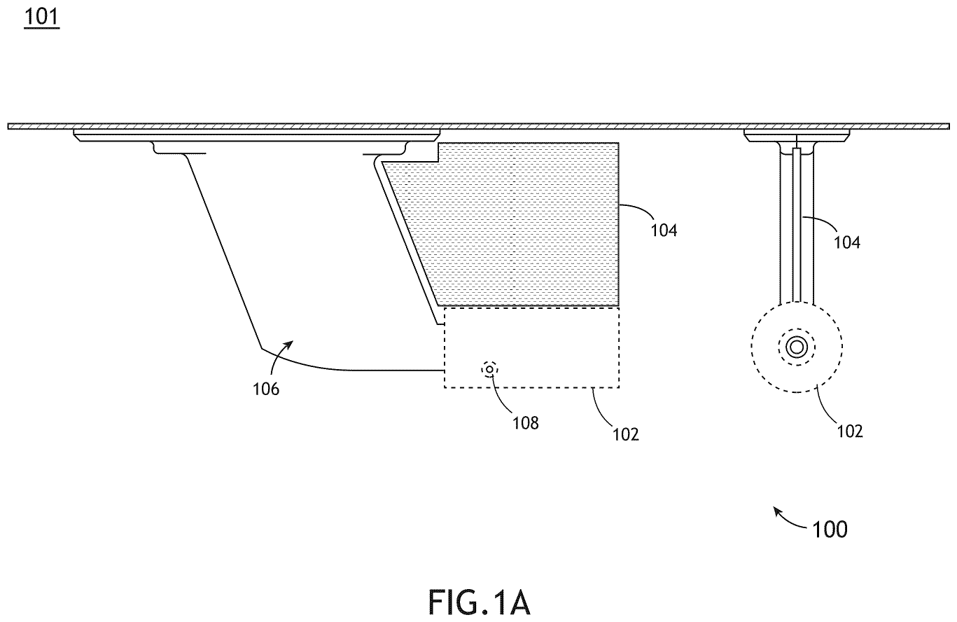

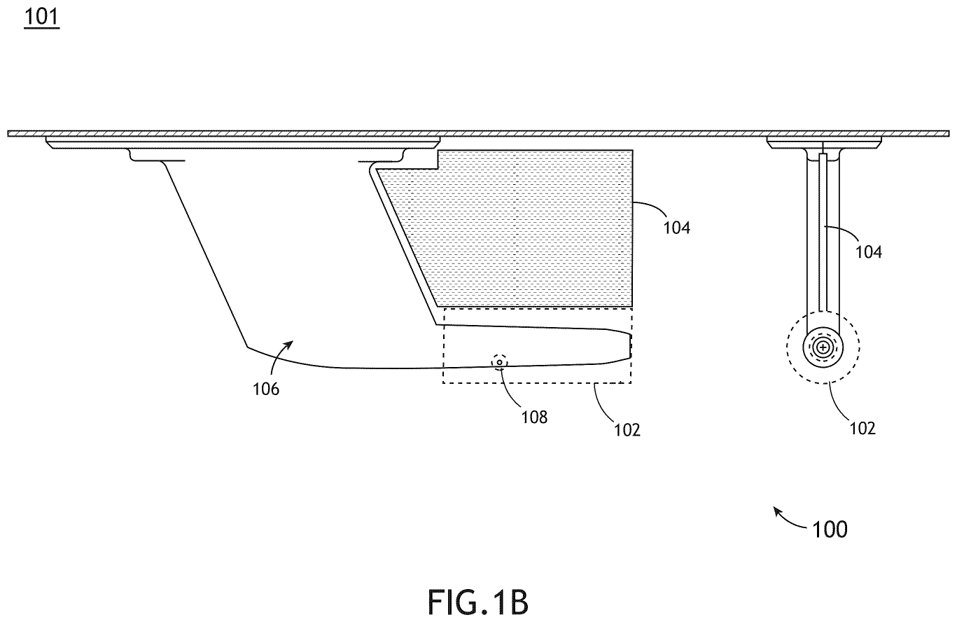

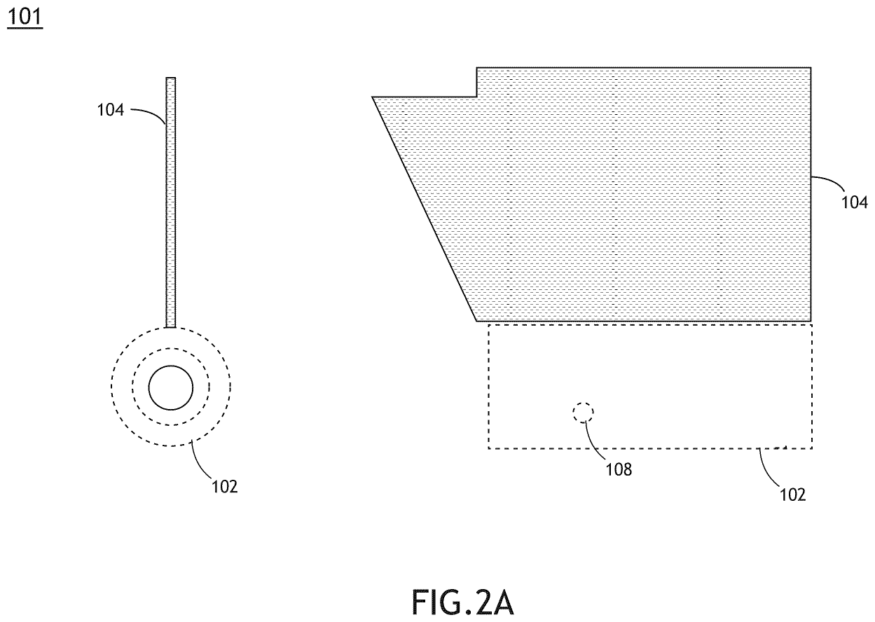

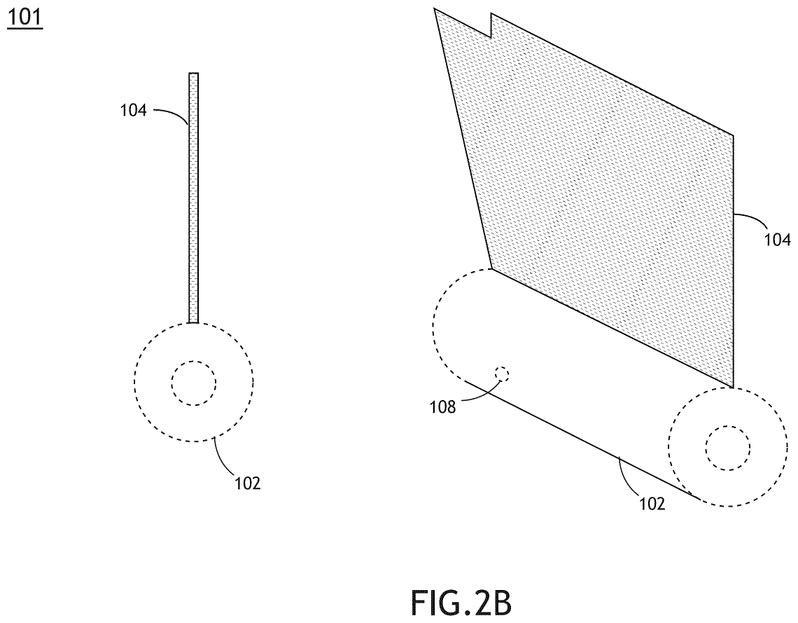

FIGS. 1A-2B illustrate perspective views of the air data probe inspection tool 100 employed on an aircraft wing, in accordance with one or more embodiments of the present disclosure.

In embodiments, the inspection tool 100 comprises a non-metallic sleeve 102 and a rigid flag 104. For example, each of the non-metallic sleeve 102 and the rigid flag 104 may be configured to facilitate visual inspection of an air data probe 106 without requiring precise measurements to be taken by an operator.

In embodiments, the non-metallic sleeve 102 is specifically designed to match a contour of a machined probe head of the air data probe 106. For example, the non- metallic sleeve 102 may be constructed from a Polyoxymethylene (POM) (i.e., Derlin) material, chosen for its durability and compatibility with aircraft environments. The sleeve 102 may be precisely engineered to fit onto the machined probe head of the air data probe 106, ensuring a snug and secure fit. Further, the sleeve 102 may include one or more indicators or markings to aid in alignment with at least one opening 108 of the air data probe 106. The alignment of the at least one opening 108 may include, but is not limited to, one or more drain holes or static ports. These openings 108 may provide reference points for proper installation depth and rotation of the inspection tool 100.

In embodiments, a bottom portion of the rigid flag 104 is coupled to a top surface of the non-metallic sleeve 102. For example, the rigid flag 104 may be coupled to the sleeve 102 in a variety of ways including, but not limited to, adhesive bonding, mechanical fastening (e.g., screws, bolts, rivets, or other fasteners), snap-fit connection, interlocking design, welding or fusion bonding, threaded connection, and the like.

In embodiments, the rigid flag 104 is configured to align with the probe strut leading edge and a top surface of a baseplate of the air data probe 106. For example, the rigid flag 104 may serve as a visual indicator during the inspection process, allowing the operator to assess the alignment and straightness of the air data probe 106 efficiently. By way of another example, an edge portion of the rigid flag 104, positioned adjacent to the strut of the air data probe 106, may run parallel with the rake angle of the strut, providing an accurate alignment assessment. Further, a top edge portion of the rigid flag 104 may be configured to run parallel to a top surface of the baseplate of the air data probe 106.

The air data probe inspection tool 100 may also include instructions or markings to guide the operator for proper alignment of the tool 100. These instructions ensure consistent and reliable use of the tool across different aircraft models and sizes. Additionally, the tool 100 may be machined to be compatible with various models and sizes of air data probes 106 used in aircraft, further enhancing its versatility.

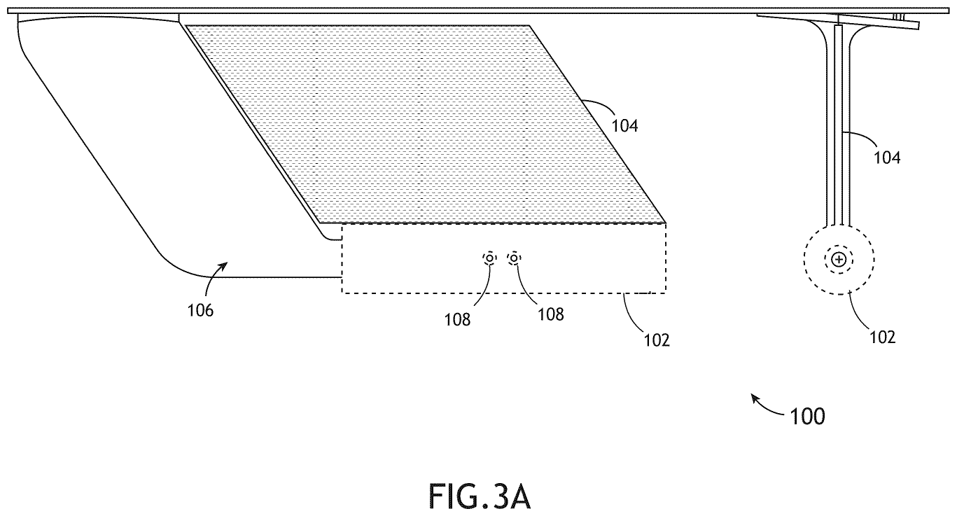

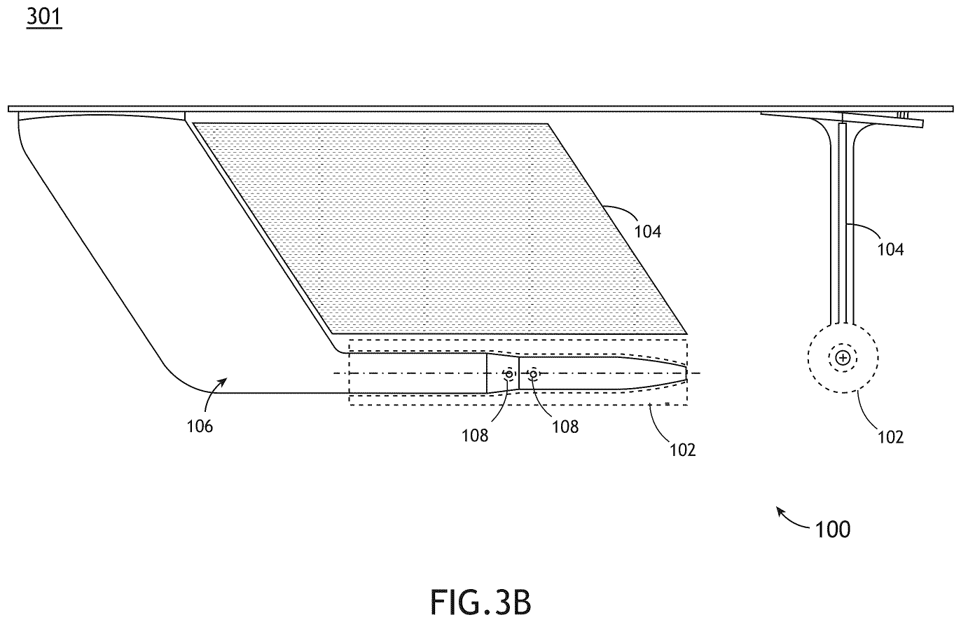

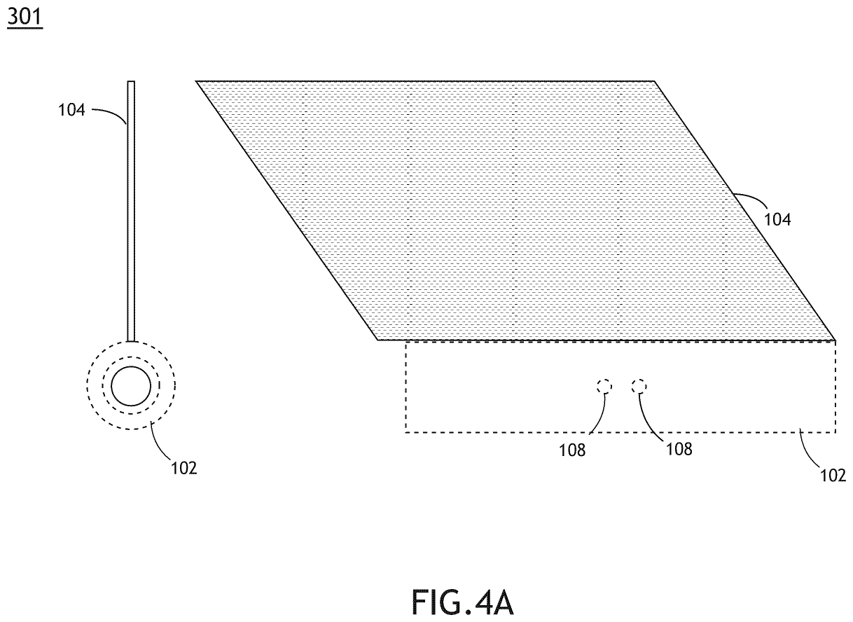

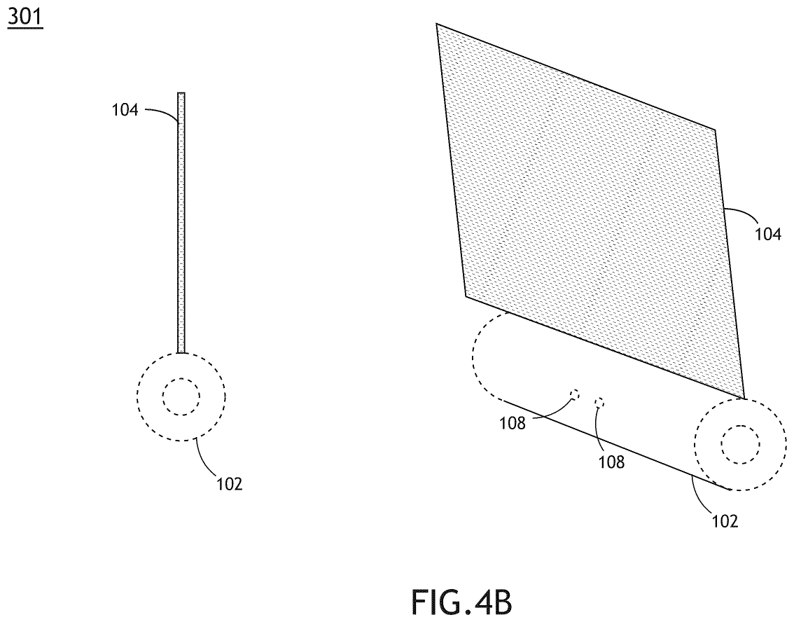

FIGS. 3A through 4B illustrate perspective views of the air data probe inspection tool 100 employed in a pitot-static system 300, in accordance with one or more embodiments of the present disclosure.

In embodiments, the air data probe inspection tool 100 is configured for use within a pitot-static system 301, providing a reliable means for assessing the alignment and straightness of air data probes 106 installed on aircraft. For instance, in the pitot-static system 301, the number and type of openings 108 may be different. The primary opening of concern is the pitot tube inlet, which measures the total pressure of the airflow. An additional opening 108 in the pitot-static system 301 may include static ports that further measure the ambient air pressure. Therefore, the air data probe inspection tool 100 may be configured to accommodate both types of openings 108 depending on the system in which it is used. The static ports may provide a reference for installation depth and rotation, which the air data probe inspection tool 100 is able to align with via the at least one opening 108.

It is noted herein that the core functionality of the air data probe inspection tool 100 remains consistent; however, there may be differences in the specific features or considerations depending on whether the tool 100 is used in a pitot system 101 or pitot-static system 301. These differences would be reflected in the design and implementation of the air data probe inspection tool 100 to ensure its effectiveness and reliability within each system.

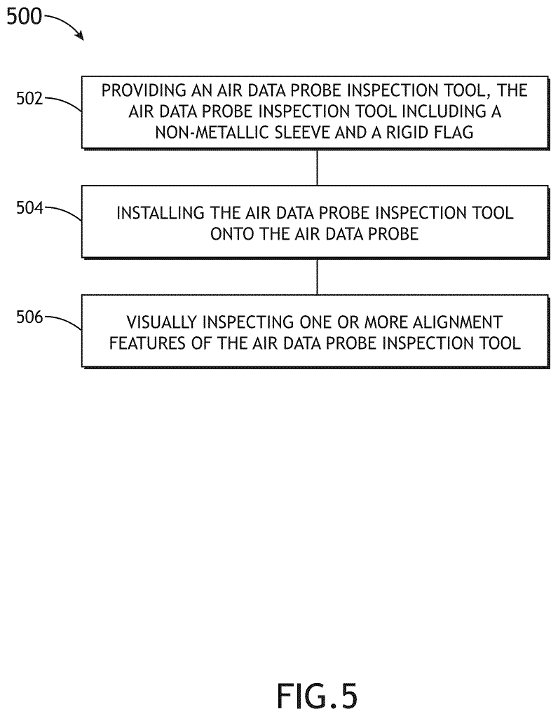

FIG. 5 is a flow diagram depicting a method for assessing alignment of an air data probe 106 installed on an aircraft, in accordance with one or more embodiments of the present disclosure.

In embodiments, the method includes a step 502 of providing an air data inspection tool 100. For example, the air data inspection tool 100 may include a non-metallic sleeve 102 and a rigid flag 104. The rigid flag 104 may be coupled to a top portion of the non-metallic sleeve 102 via an adhesive bonding, a mechanical fastening (e.g., screws, bolts, rivets, or other fasteners), snap-fit connection, interlocking design, welding or fusion bonding, threaded connection, and the like.

In embodiments, the method includes a step 504 of installing the inspection tool 100 onto the air data probe 106. For example, the non-metallic sleeve 102 of the air data probe inspection tool 100 may be precisely engineered to fit onto the machined probe head of the air data probe 106, ensuring a snug and secure fit. Further, the sleeve 102 may include one or more indicators or markings to aid in alignment with at least one opening 108 of the air data probe 106.

In embodiments, the method includes a step 506 of visually inspecting one or more alignment features of the air data probe inspection tool 100. For example, the rigid flag 104 may be configured to align with the probe strut leading edge and a top surface of a baseplate of the air data probe 106. By way of another example, an edge portion of the rigid flag 104, positioned adjacent to the strut of the air data probe 106, may run parallel with the rake angle of the strut. Further, the sleeve 102 may include one or more indicators or markings to aid in alignment with at least one opening 108 of the air data probe 106. The alignment of at least one opening 108 may include, but is not limited to, one or more drain holes or static ports. These openings 108 may provide reference points for proper installation depth and rotation of the inspection tool.

It is noted herein that the number of openings 108 and other features designed for the air data probe inspection tool 100 may be modified depending on whether it is used for a pitot system 101 or a pitot-static system 301. It is further noted that the air data probe inspection tool 100 is not limited to be used on air data probes 106, yet it may also be employed for assessing alignment and straightness of air temperature probes.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An air data probe inspection tool, comprising:
a non-metallic sleeve configured to match a contour of a machined probe head of an air data probe, wherein the non-metallic sleeve is configured to fit onto the machined probe head and align with at least one opening of the air data probe; and
a rigid flag coupled to the non-metallic sleeve, the rigid flag being configured to align with a probe strut leading edge and a top surface of a baseplate,
wherein the non-metallic sleeve and the rigid flag are configured to facilitate visual inspection for at least a misalignment or bending of the air data probe during installation or maintenance procedures.

2. The air data probe inspection tool of claim 1, wherein an edge of the rigid flag, positioned adjacent to the strut of the air data probe, aligns with a rake angle of the strut.

3. The air data probe inspection tool of claim 1, wherein at least one of the non-metallic sleeve and the rigid flag provide one or more visual checks for alignment or straightness of the air data probe without requiring any measurements to be taken by an operator.

4. The air data probe inspection tool of claim 1, wherein the at least one opening of the air data probe includes at least one of: one or more drain holes or one or more static ports.

5. The air data probe inspection tool of claim 4, wherein the at least one of: the one or more drain holes or the one or more static ports are configured to provide a reference for an installation depth and rotation of at least one of the non-metallic sleeve and the rigid flag.

6. The air data probe inspection tool of claim 1, wherein the non-metallic sleeve comprises a Polyoxymethylene (POM) material.

7. The air data probe inspection tool of claim 1, wherein the non-metallic sleeve includes one or more indicators to aid in alignment with the at least one opening of the air data probe.

8. The air data probe inspection tool of claim 1, further comprising at least one of:
instructions or markings on the inspection tool to guide an operator for proper alignment of the inspection tool.

9. The air data probe inspection tool of claim 1, wherein at least one of: the non-metallic sleeve and the rigid flag are machined to be compatible with various models and sizes of air data probes used in aircraft.

10. The air data probe inspection tool of claim 1, wherein the air data probe inspection tool is further configured to be employed for assessing alignment and straightness of air temperature probes.

11. A method for assessing alignment of an air data probe installed on an aircraft, comprising:
providing an air data inspection tool, the air data inspection tool comprising:
a non-metallic sleeve configured to match a contour of a machined probe head of an air data probe, wherein the non-metallic sleeve is configured to fit onto the machined probe head and align with at least one opening of the air data probe; and
a rigid flag coupled to the non-metallic sleeve, the rigid flag being configured to align with a probe strut leading edge and a top surface of a baseplate of the air data probe;
installing the inspection tool onto the air data probe; and
visually inspecting one or more alignment features of the air data probe inspection tool.

12. The method of claim 11, further comprising visually inspecting the alignment of an edge of the rigid flag, positioned adjacent to the strut of the air data probe, with a rake angle of the strut.

13. The method of claim 11, wherein the visual inspection of the air data probe is performed without requiring any measurements to be taken by an operator.

14. The method of claim 11, wherein the at least one opening of the air data probe includes at least one of: one or more drain holes or one or more static ports.

15. The method of claim 14, wherein the at least one of: the one or more drain holes or the one or more static ports are configured to provide a reference for an installation depth and rotation of at least one of the non-metallic sleeve and the rigid flag.

16. The method of claim 11, wherein the non-metallic sleeve comprises a Polyoxymethylene (POM) material.

17. The method of claim 11, wherein the non-metallic sleeve includes one or more indicators to aid in alignment with the at least one opening of the air data probe.

18. The method of claim 11, further comprising providing one or more instructions or markings on the inspection tool to guide an operator for proper alignment of the inspection tool with the air data probe.

19. The method of claim 11, wherein at least one of: the non-metallic sleeve and the rigid flag are machined to be compatible with various models and sizes of air data probes used in an aircraft.

20. The method of claim 11, wherein the air data probe inspection tool is further configured to be employed for assessing an alignment and straightness of air temperature probes.
